(19) United States
(12) Patent Application Publication
(10) Pub. No.: US 2002/0198814 A1
(43) Pub. Date: Dec. 26, 2002

(54) Online e-commerce transactions incorporating determination of end-to-end costs

(75) Inventors: Vipul Bansal, New Delhi (IN); Abhinanda Sarkar, New Delhi (IN)

Correspondence Address: INTERNATIONAL BUSINESS MACHINES CORPORTION, ALMADEN RESEARCH CENTER, 650 HARRY ROAD, SAN JOSE,, CA, 95120, US

(73) Assignee: International Business Machines Corporation, Armonk, NY (US)

(21) Appl. No.: 09/887,629

(22) Filed: Jun. 22, 2001

(51) Int. Cl. G06F 17/60

(52) U.S. Cl. 705/37

(57) ABSTRACT

The present invention discloses a computer implementable system, method and computer program product for conducting online negotiation and matchings for electronic commerce spanning international boundaries and includes means for computation of end-to-end costs for potential transactions including the determination of various intermediate costs like shipping costs, taxes and duties, various fees and commissions and the like. It further includes means for incorporating the computed end-to-end costs in determining the market allocations and prices, thus leading to more informed buying and selling decisions.

### FIELD OF INVENTION

The present invention relates to online e-commerce transactions incorporating determination of end-to-end costs. It can be suitably applied in the context of a large number of online market mechanisms, for example, catalogue sales, auctions, and two-way trading.

### BACKGROUND OF THE INVENTION

Electronic commerce over the Internet is rapidly increasing day by day and is poised to constitute a significant portion of overall commerce worldwide in the coming years. Significant advances in the areas of computer and communication technologies have made possible a seamless exchange of information between electronic devices which may be located all over the world. Online mechanisms for buying and selling over the Internet (for example, catalogue sales, auctions of various kinds, and two-way trading) have come into existence and are being widely used. These have led to the creation of online shops (for example: http://www.amazon.com), online auction markets (for example: http://auctions.yahoo.com) and other online marketplaces for buying and selling various kinds of components and goods. Newer forms of electronic marketplaces with different market structures and business models are being created almost everyday.

Despite the technological developments and the increasing popularity of the Internet as a medium for doing commerce, much of the electronic commerce remains confined to localized geographical groups and within respective countries. This phenomenon is due to the fact that an end-to-end commerce transaction needs to take into account a large number of issues which are not adequately handled by the existing systems and models for electronic commerce. These include: (a) issues related to physical delivery like shipping cost, and (b) handling payment of various commissions, fees, duties and taxes that may be necessary.

Most online markets handle physical delivery issues on a ‘post-transaction’ basis, i.e., the shipping costs (and other similar costs) are added to the base product price once the transaction (to buy or sell) is finalized to arrive at the total price for the buyer. The calculation of shipping cost is often done by the online site itself and the web site manages the logistics either on its own or through other agencies. An example of such a system which involves managing deliveries of purchased goods from a distribution center (merchant) to multiple receivers (customers) is disclosed in U.S. Pat. No. 6,085,170 (Delivery Managing System) issued on Jul. 4, 2000 to Tsukuda.

Alternatively, third party services are used—these may be online services or specialized Web sites which provide information on shipment rates. For example, U.S. Pat. No. 6,064,981 (Method for Online Display and Negotiation of Cargo Rates) issued on May 16, 2000 to Barni and Miller discloses a method using which customers can obtain shipping rates from various providers from a single web site and accept a rate from amongst the posted rates; or else they can participate in online auctions on the web site for obtaining shipping services at competitive prices.

A large number of payments or charges may be involved in a complete electronic commerce transaction. These may include (a) charges for online services enabling e-commerce, (b) insurance, (c) fees for various other financial services like providing credit information and appraisal services, executing monetary transfers, providing advisory services, providing document handling services and others, and (d) various duties and taxes. Most online markets either ignore these issues altogether or handle them wholly or partly in a piecemeal fashion which is why electronic commerce has not really taken off in instances where these costs are not insignificant compared to the price of the items and in instances where these costs vary substantially across different buyers and sellers.

U.S. Pat. No. 5,987,429 (Computer Based Fee Processing for Electronic Commerce) issued on Nov. 16, 1999 to Maritzen and Wescott describes a system and method for automatic tracking, calculation and payment of taxes and other fees that become due as a result of conducting an e-commerce transaction. The system disclosed in the invention is a post-transaction system since it considers the various payments only after a transaction has been completed. Various other systems for computing taxes and other fees have been described in prior art; however they are also post-transaction systems.

The prior art does not provide adequate means for seamless e-commerce transactions across international borders wherein all the major components of end to end costs for a potential transaction in an online market can be determined beforehand and utilized for making more informed buying and selling decisions which benefit the buyers as well as the sellers.

### THE OBJECT AND SUMMARY OF THE INVENTION

The object of the present invention is to provide online negotiations for global electronic commerce incorporating end-to-end costs, which substantially overcomes or at least ameliorates one or more deficiencies of the existing arrangements.

To achieve the said objective, the present invention provides a method for enabling the online determination of end-to-end costs while negotiating e-commerce transaction comprising:

maintaining an updated online database of prices associated with each significant cost element relevant to goods or services involved in completing said transaction,

maintaining an updated online database of procedures and rules associated with each activity involved in completing said transaction,

determining the costs associated with each significant cost element by accessing the price data corresponding to the parameters of said transaction,

aggregating all said costs to arrive at a total end-to-end cost for said transaction.

The above method is further utilized for determining:

the set of e-commerce transactions that should take place and the set of e-commerce transactions that should not take place from amongst the various possibilities,

the prices to be paid by buyers, the amounts to be received by the sellers and the payments to be made to other service providers for the transactions that should take place.

The said cost elements include shipping and handling costs, other logistics management costs, taxes as well as finance costs.

The said databases are located either at the supplier end or at the buyer end or may be hosted by a third party.

The said procedures and rules include formalities to be completed and payments to be made for complying with statutory requirements at each end and intermediate step of said transaction.

The said method is implemented by an online intermediary providing said facilities as a service either against a fee of commission or free of charge.

The above method is applied to a transaction between a single buyer and a single seller negotiating online.

The above method is applied to online auctions between a seller and multiple buyers.

The said method is also applied to online reverse auctions between a buyer and multiple sellers.

The above method is further applied to two-sided matching markets involving multiple buyers and sellers.

The winning bid for the desired goods or services in an online auction is selected on the basis of highest net payout to the seller after deduction of said computed cost elements (shipping, logistics, fees, commissions).

The winning offer for the desired goods or services in an online reverse auction is selected on the basis of lowest net cost to the buyer after addition of said computed cost elements (shipping, logistics, fees, commissions).

A minimum required qualifying bid amount is communicated to a potential bidder in response to request for the information about the current status of the auctions.

A maximum allowable offer amount is communicated to a potential seller in response to request for the information about the current status of the reverse auctions.

The sell orders resident in the database are shown to a potential buyer alter online addition of said computed cost elements (shipping, logistics, fees, commissions) to the price quoted by seller for each of the sell orders in response to request for such information in a two-sided matching market.

The buy orders resident in the database are shown to a potential seller after online deduction of said computed cost elements (shipping, logistics, fees, commissions) from the price quoted by buyer for each of the sell orders in response to request for such information in a two-sided matching market.

The resident sell orders are prioritized for matching an incoming buy order in the increasing order of the total cost computed by addition of said computed cost elements (shipping, logistics, fees, commissions) to the price quoted by seller for each of the sell orders in a two-sided matching market.

The resident buy orders are prioritized for matching an incoming sell order in the decreasing order of the net price computed by deduction of said computed cost elements (shipping, logistics, fees, commissions) to the price quoted by buyer for each of the buy orders in a two-sided matching market.

The instant invention further provides a system for enabling the online determination of end-to-end costs while negotiating e-commerce transaction comprising:

means for maintaining an updated online database of prices associated with each significant cost element relevant to goods or services involved in completing said transaction,

means for maintaining an updated online database of procedures and rules associated with each activity involved in completing said transaction,

means for determining the costs associated with each significant cost element by accessing the price data corresponding to the parameters of said transaction,

means for aggregating all said costs to arrive at a total end-to-end cost for said transaction.

The above system is further utilized for determining:

the set of e-commerce transactions that should take place and the set of e-commerce transactions that should not take place from amongst the various possibilities,

the prices to be paid by buyers, the amounts to be received by the sellers and the payments to be made to other service providers for the transactions that should take place.

The said cost elements include shipping and handling costs, other logistics management costs, taxes as well as finance costs.

The said databases are located either at the supplier end or at the buyer end or may be hosted by a third party.

The said procedures and rules include formalities to be completed and payments to be made for complying with statutory requirements at each end and intermediate step of said transaction.

The said system is used by an online intermediary providing said facilities as a service either against a fee of commission or free of charge.

The above system is used for a transaction between a single buyer and a single seller negotiating online.

The above system is used for online auctions between a seller and multiple buyers.

The said system is used for online reverse auctions between a buyer and multiple sellers.

The above system is further used for two-sided matching markets involving multiple buyers and sellers.

The above system includes means for selecting the winning bid for the desired goods or services in an online auction on the basis of highest net payout to the seller after deduction of said computed cost elements (shipping, logistics, fees, commissions).

The above system includes means for selecting the winning offer for the desired goods or services in an online reverse auction on the basis of lowest net cost to the buyer after addition of said computed cost elements (shipping, logistics, fees, commissions).

The above system includes means for communicating minimum required qualifying bid amount to a potential bidder in response to request for the information about the current status of the auctions.

The above system includes means for communicating maximum allowable offer amount to a potential seller in response to request for the information about the current status of the reverse auctions.

The above system includes means for showing the sell orders resident in the database to a potential buyer after online addition of said computed cost elements (shipping, logistics, fees, commissions) to the price quoted by seller for each of the sell orders in response to request for such information in a two-sided matching market.

The above system includes means for showing the buy orders resident in the database to a potential seller after online deduction of said computed cost elements (shipping, logistics, fees, commissions) from the price quoted by buyer for each of the sell orders in response to request for such information in a two-sided matching market.

The above system includes means for prioritizing the resident sell orders for matching an incoming buy order in the increasing order of the total cost computed by addition of said computed cost elements (shipping, logistics, fees, commissions) to the price quoted by seller for each of the sell orders in a two-sided matching market.

The above system includes means for prioritizing the resident buy orders for matching an incoming sell order in the decreasing order of the net price computed by deduction of said computed cost elements (shipping, logistics, fees, commissions) to the price quoted by buyer for each of the buy orders in a two-sided matching market.

The instant invention further provides a computer program product comprising computer readable program code stored on computer readable storage medium embodied therein for enabling the online determination of end-to-end costs while negotiating e-commerce transaction comprising:

computer readable program code means configured for maintaining an updated online database of prices associated with each significant cost element relevant to goods or services involved in completing said transaction,

computer readable program code means configured for maintaining an updated online database of procedures and rules associated with each activity involved in completing said transaction,

computer readable program code means configured for determining the costs associated with each significant cost element by accessing the price data corresponding to the parameters of said transaction,

computer readable program code means configured for aggregating all said costs to arrive at a total end-to-end cost for said transaction.

The above computer program product is further utilized for determining:

the set of e-commerce transactions that should take place and the set of e-commerce transactions that should not take place from amongst the various possibilities,

the prices to be paid by buyers, the amounts to be received by the sellers and the payments to be made to other service providers for the transactions that should take place.

The said cost elements include shipping and handling costs, other logistics management costs, taxes as well as finance costs.

The said databases are located either at the supplier end or at the buyer end or may be hosted by a third party.

The said procedures and rules include formalities to be completed and payments to be made for complying with statutory requirements at each end and intermediate step of said transaction.

The said computer program product is implemented by an online intermediary providing said facilities as a service either against a fee of commission or free of charge.

The above computer program product is configured for a transaction between a single buyer and a single seller negotiating online.

The above computer program product is configured for online auctions between a seller and multiple buyers.

The said computer program product is configured for online reverse auctions between a buyer and multiple sellers.

The above computer program product is further configured for two-sided matching markets involving multiple buyers and sellers.

The said computer program product includes computer readable program code means configured for selecting the winning bid for the desired goods or services in an online auction on the basis of highest net payout to the seller after deduction of said computed cost elements (shipping, logistics, fees, commissions).

The above computer program product includes computer readable program code means configured for selecting the winning offer for the desired goods or services in an online reverse auction on the basis of lowest net cost to the buyer after addition of said computed cost elements (shipping, logistics, fees, commissions).

The above computer program product includes computer readable program code means configured for communicating minimum required qualifying bid amount to a potential bidder in response to request for the information about the current status of the auctions.

The above computer program product includes computer readable program code means configured for communicating maximum allowable offer amount to a potential seller in response to request for the information about the current status of the reverse auctions.

The instant computer program product includes computer readable program code means configured for showing the sell orders resident in the database to a potential buyer after online addition of said computed cost elements (shipping, logistics, fees, commissions) to the price quoted by seller for each of the sell orders in response to request for such information in a two-sided matching market.

The above computer program product includes computer readable program code means configured for showing the buy orders resident in the database to a potential seller after online deduction of said computed cost elements (shipping, logistics, fees, commissions) from the price quoted by buyer for each of the sell orders in response to request for such information in a two-sided matching market.

The above computer program product includes computer readable program code means configured for prioritizing the resident sell orders for matching an incoming buy order in the increasing order of the total cost computed by addition of said computed cost elements (shipping, logistics, fees, commissions) to the price quoted by seller for each of the sell orders in a two-sided matching market.

The above computer program product includes computer readable program code means configured for prioritizing the resident buy orders for matching an incoming sell order in the decreasing order of the net price computed by deduction of said computed cost elements (shipping, logistics, fees, commissions) to the price quoted by buyer for each of the buy orders in a two-sided matching market.

### BRIEF DESCRIPTION OF THE DRAWINGS

The invention will now be described with reference to accompanying drawings:

FIG. 1 shows the block diagram of the system for conducting e-commerce transactions incorporating online determination of end-to-end costs, according to this invention.

FIG. 2 shows a specific instance of the system in which the online intermediary is implemented in the form of four sub systems.

FIG. 3 shows the flow chart wherein the important actions taken by the online market intermediary are shown.

FIG. 4 shows action of market intermediary for an online ascending auction.

FIG. 5 shows the flow chart of action of market intermediary for two-sided continuous matching.

### DETAILED DESCRIPTION OF THE DRAWINGS

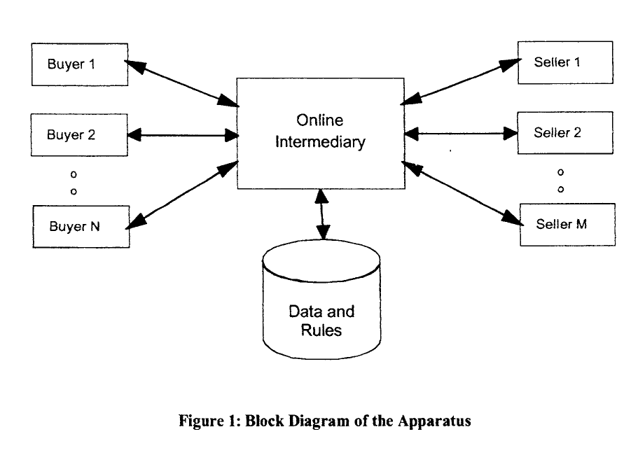

Referring to the drawings, FIG. 1 shows one or more potential buyers, labeled from 1 through N and one or more potential sellers, labeled from 1 through M. The buyers and sellers may be humans using any form of electronic device like personal computers, mobile phones, interactive televisions etc. or may even consist of software agents running on electronic devices acting on behalf of individuals and organizations.

The online negotiations are facilitated by an online intermediary which can assume one of a large number of possible configurations: the intermediary may be implemented in software and may be co-located with one or more buyer or seller systems, or it may be implemented as an independent system (or a combination of multiple independent subsystems). The online intermediary or its various subsystems may be implemented in software running over any commercial computer systems. The online intermediary may store various kinds of data, for example, data on buyers and sellers; data on status of ongoing negotiations; data for computing shipping costs, taxes and fees and commissions of various kinds; and other auxiliar data. It may also store set of rules governing the online negotiations and rules governing various other computations. These data and rules may be stored by the online intermediary either within the same computer system or on one or more separate systems electronically accessible to it.

The buyers 1 . . . N and the sellers 1 . . . M are connected to the online intermediary by electronic means and can exchange communication messages with the online intermediary.

The buyers and sellers taking part in the online negotiation are typically known to the online intermediary through a prior registration process which may be online or off-line or both.

The online intermediary conducts the online negotiations. It receives buy and sell offers from buyers and sellers and obtains or computes the various components of end to end costs (like shipping costs, taxes, other commissions etc.) for the potential transactions that can result from them. It makes use of these costs and determines the allocation of items to buyers and the prices to be paid by the buyers, the amounts to be received by the sellers and the various other payments to be made.

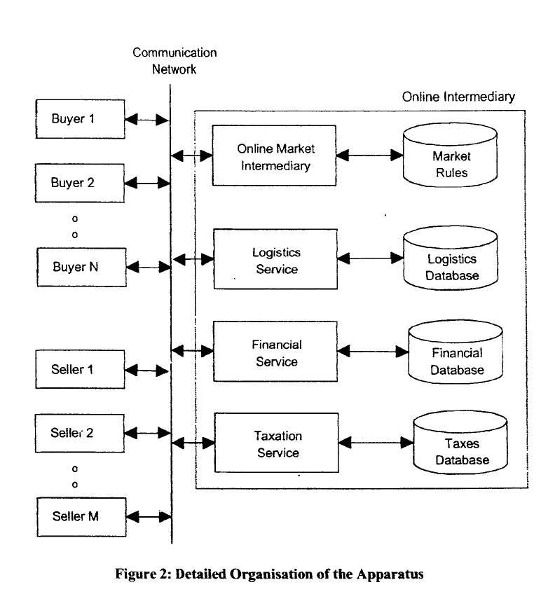

FIG. 2 shows a specific instance of the system in which the online intermediary is implemented in the form of four subsystems, namely (a) an online market intermediary, (b) a logistics service, (c) a financial service, and (d) a taxation service. The buyers and sellers are communicatively coupled to the various subsystems and to each other through a communication network which may be any private or public network including the Internet.

The four subsystems of the online intermediary shown in the instance of FIG. 2 may perform the following functions:

1. Online Market Intermediary: It coordinates the online negotiations by activities such as: (a) receiving offers to buy or sell offers (proposals to buy or sell specified items at specified prices) from buyers and sellers, (b) maintaining past and present information on buyers and sellers and on the status and history of the ongoing online negotiations, and providing portions of this information to buyers and sellers when needed, (c) obtaining information on various cost components for potential transactions from other online services when needed, (d) facilitating the determination of the allocation and prices of items, and of various payments to be made by utilizing information obtained from buyers and sellers and from various online services, and (e) facilitating contracts and payments between itself, buyers, sellers and various online services for executing the completed transactions.

The online market intermediary typically has a set of market rules which govern the online negotiations. These may be ideally stored in a database and can be configured from time to time.

2. Logistics Service: This is an online service, which provides information on costs associated with physical delivery of items from sellers to buyers, the term shipping costs is used to denote all applicable transportation charges. The online market intermediary would typically provide it with information like locations of the buyers and sellers, characteristics of the items to be shipped, mode of shipping and the delivery period and request for the corresponding feasible shipping alternatives and their costs. This service may be run by the market intermediary itself, or by an independent party and may even be a Web site of some shipping organization. It typically has a logistics database which stores information on shipping alternatives and costs for various locations and item characteristics. The logistics service provider may also provide contractable rates and execute the physical delivery of items for the transactions.

3. Financial Service: The financial service may provide financial information like credit quality information, or insurance services, or information pertaining to pricing of derivatives, or some other services for a fee or commission. It may also enable electronic payments between various entities for the electronic commerce transactions. The provider of this service is typically a financial organization and may maintain a financial database for storing information.

4. Taxation service: The electronic commerce transactions may be subject to various kinds of taxes. For example, the proceeds to sellers may be taxed on a gross basis or a value added basis. Further, the buyers may also need to pay tariffs for importing the items into their respective countries. The taxation service provides online computation of taxes for a potential transaction between a buyer and a seller. It may utilize a database which contains the tax-related information on various countries, items etc. for this purpose. This service may be provided by government agencies, or by independent parties or by the online market intermediary itself.

It may be noted that the online market intermediary need not be restricted to using a specific logistics service, or a specific financial service or a specific taxation service or any other such service. It may use any such similar service which may be commercially available over the communication network which adequately meets its requirements.

It may be further noted that the online market intermediary does not necessarily need to obtain information on all such items such as shipping costs, taxes, duties, various commissions and fees etc. It can choose to obtain information on only those components which are expected to be a significant compared to the cost of the item being transacted and ignore the effects of the other components in the determination of the allocation of items from sellers to buyers. This choice can also be customized by the buyers and/or sellers.

### PREFERRED EMBODIMENTS OF THE INVENTION

The preferred embodiment consists of means enabling online negotiation and matching for electronic commerce with support for online computation of the significant components of end to end costs for potential transactions and utilizing this information in the determination of the allocation of items from sellers to buyers as well as the prices to be paid by the buyers, the amounts to be received by the sellers and the various other payments involved in the complete transaction.

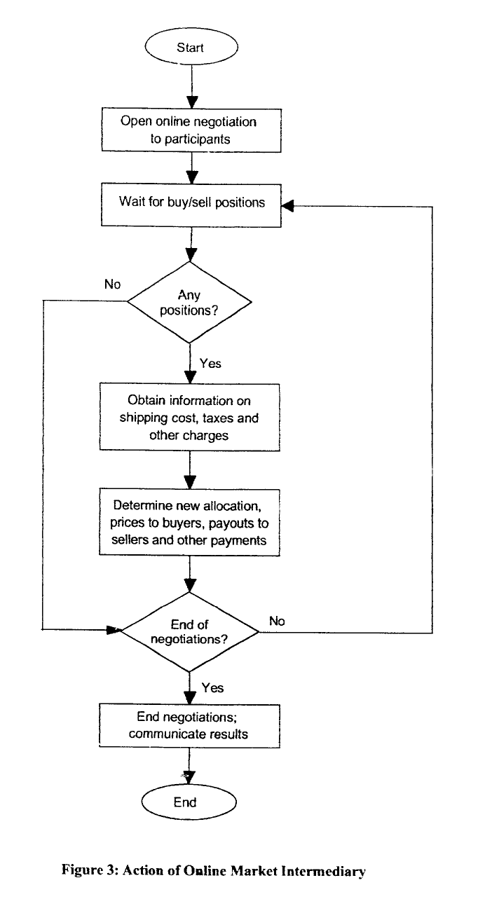

This embodiment is explained in the flowchart given in FIG. 3, wherein the important actions taken by the online market intermediary are shown.

The process typically starts with the online market intermediary opening the online negotiation to participants. This can happen in many ways, for example, by putting an item for online display for catalogue sales, announcing an online auction for the sale or purchase of one or more items, by putting an item in a two-way exchange, or by sending messages to participants for personalized negotiation.

The market intermediary would then typically wait for receiving buy and sell positions from buyers and sellers. The buyers and sellers may have the capability to communicate with the market intermediary for inquiring the status of the ongoing negotiation. They may express their desire to transact with specified conditions (for example, item, quantity, quality, price, delivery date, delivery location and other attributes) by way of submitting positions to the market intermediary. When the market intermediary receives any such position, it obtains the relevant information on the various components of the end to end costs relevant for the transactions related to the new position if it were to be accepted. This may include, for example, determining the shipping cost (with the help of logistics service), determining the commissions and fees for various financial services to be availed (with the help of financial service) and determining of the relevant taxes to be paid (with the help of taxation service).

The online market intermediary now uses the information contained in the new position and the information just obtained on end-to-end costs in conjunction with the information that it already has on the status and history of the ongoing negotiation to determine the new allocation of items from sellers to buyers, the prices to be paid by various buyers, the amounts to be received by various sellers, the amounts to be paid as shipping cost, the amount to be paid as taxes, duties, fees, commissions and other such charges comprising the end to end costs for all the transactions that may result from the online negotiation, if no more positions were to be received in the given online negotiation.

The market intermediary now checks if the negotiations have reached a completion. If not, it goes back into the waiting mode to receive more positions from the participants. If the negotiations have indeed reached a conclusion (due to expiry of scheduled time, or due to the intermediary not receiving any new positions for a specified length of time, or due to all items having been sold, or any other reason specified in the market rules) then the market intermediary closes the negotiations and communicates the results of the negotiations to the respective participants. It may also facilitate or intermediate the booking of various contracts (for example agreements between buyers and sellers, contracts with shipping and financial services etc.) and the online execution of payments to various entities.

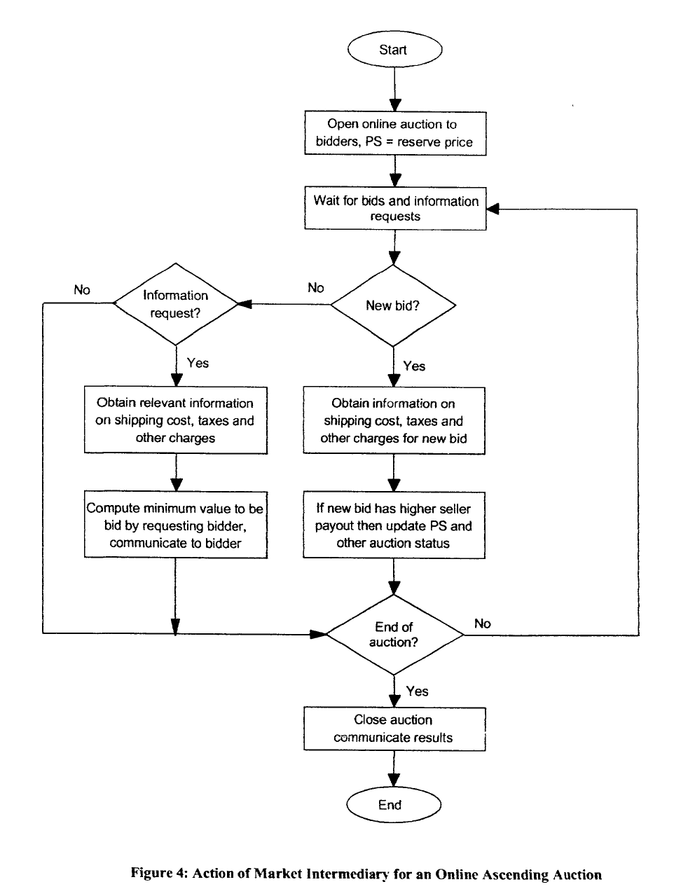

A specific embodiment of the present invention is described below with the help of the flow chart in FIG. 4 and a practical worked out example below. The specific implementation utilizes an online auction as the market mechanism for online negotiation.

Online ascending auctions for sale of items are very popular on the Internet and are widely used for selling millions of articles on Web sites such as http://auctions.yahoo.com and http://www.ebay.com. The flow chart in FIG. 4 shores the important actions taken by the online market intermediary in an online ascending auction for sale of items in accordance with the present invention. The auction may have one or more copies of one or more items on sale on a Web site which is accessible to potential buyers (bidders) over the communication network. For simplicity of description here, it is considered that all bids are for a single unit of an item. It is also assumed that the seller of an item wishes to receive a minimum price (reserve price) for the item, below which it will not sell the item.

The online market intermediary initiates the online auction by announcing the auction on the web site and/or sending messages to potential bidders. It determines a value called current payout to seller (denoted by PS) which represents at any time during the auction (after one or more bids have been received), the amount that the seller would receive if the auction were to close there and then. At the time of initiating the auction, PS is initialized to the reserve price specified by the seller.

The market intermediary then waits for any messages from the potential bidders. The messages may comprise new bids and information requests, besides other routine messages. Any bidder can request for current status of the auction or place a bid in the online auction at any time before the auction is declared closed by the market intermediary.

When the market intermediary receives a message, which is not a new bid, but is an information request from a potential bidder, it typically handles the request as follows: For the bidder seeking the information, the market intermediary obtains relevant information on the various components of the end-to-end costs that would apply if the new bid were to be accepted. This may include, for example, determining the shipping cost, determining the commissions and fees for various financial services to be availed and determining of the relevant taxes to be paid. The market intermediary determines the minimum value of the bid that can be placed by the requesting bidder by computing a monetary value such that if the bidder were to place a new bid for that value, then the net payout to the seller (i.e., the new value of PS), after accounting for all the other costs (like shipping costs, taxes etc.) would be at least a specified number of monetary units (denoted by E) greater than the value of PS implied by the current winning bid. The intermediary communicates this amount to the potential bidder.

When the market intermediary receives a message, which is indeed a new bid, it obtains relevant information on the various components of the end to end costs that would apply if the new bid were to be accepted. This may include, for example, determining the shipping cost, determining the commissions and fees for various financial services to be availed and determining of the relevant taxes to be paid. Using this information, the market intermediary computes the net payout to the seller implied by the new bid. If this amount exceeds the current PS by at least a minimum specified amount (E), then the new bid is accepted and the auction status, including the current value of PS, is updated.

After serving an information request or after accepting or rejecting a new bid, the market intermediary checks if the auction should now be closed in accordance with the rules of the auction. If not, it goes back into the waiting mode to receive more bids and/or information requests. If yes, it closes the auction for bidding and the highest outstanding bid becomes the winner.

The above description can be further elaborated with the help of a worked out example as follows. Consider an online ascending auction selling a popular book, with the reserve price of USD 20 and minimum required bid increment of USD 5 for each new bid. Let us consider the actions of three bidders (A, B and C) participating in this auction. A, B and C are located in different countries and in a country different from the seller's country. The end-to-end costs for a transaction are assumed to consist of (a) payout to seller, (b) shipping cost, (c) import tariff (tax), and (d) commissions and fees for financial and other services. The applicable shipping costs (denote by S) are USD 10 for bidder A, USD 5 for bidder B, and USD 15 for bidder C. The buyers need to pay import tariffs (denote by T) at the following rates: 20% (bidder A), 30% (bidder B) and 10% (bidder C). The overall commissions and fees (denote by F) for financial services (insurance, document handling, etc.) and the services of the market intermediary work out to: 6% (bidder A), 4% (bidder B) and 8% (bidder C). Note that the shipping costs are fixed in US Dollars while the tariffs (taxes) and the fees and commissions are charged as percentage of the payout to seller (denote seller payout by PS).

The market intermediary starts the online auction by setting: current seller payout PS=reserve price=USD 20. Now, suppose the bidder B requests the market intermediary for information on the value of bid to be placed by it. The market intermediary obtains the relevant information on the shipping cost (S_{B}=USD 5), import tariff (T_{B}=30%) and commissions and fees (F_{B}=4%). It now computes the minimum new bid for bidder B as NEWBID_{B}=S_{B}+(PS+E)*(1+T_{B}+F_{B}). This is the amount which if the bidder B pays, would lead to a net payout of (PS+E) to the seller. This is determined to be USD 5+(20+5)*(1+0.30+0.04)=USD 38.5. The market intermediary communicates this required amount to the bidder B.

The bidder B now places a bid of USD 40 in the auction. The market intermediary now sets the new seller payout (PS) to be USD (40−S_{B})/(1+T_{B}+F_{B}) which equals USD (40−5)/(1+0.30+0.04)=USD 26.12. It then waits for more bids from bidders.

Suppose bidder C wishes to outbid bidder B and asks the market intermediary for the minimum value of the new bid it should place. The market intermediary computes this value to be NEWBID_{C}=S_{C}+(PS+E)*(1+T_{C}+F_{C})=USD 15+(26.12+5)*(1+0.10+0.08)=USD 51.72. On receiving information on the minimum required new bid value, suppose the bidder C placed a new bid of USD 51.72. The market intermediary now updates the value of as seller payout to PS=USD 31.12 as done earlier.

Suppose no more bids are received now and the market intermediary closes the auction. Thus, bidder C wins the auction and pays USD 51.72. Out of this amount, USD 31.12 goes to the seller, USD 15.00 is the shipping cost, USD 3.11 is paid as import tariff and USD 2.49 is paid as various fees and commissions to the financial intermediary and the market intermediary.

The description above applied to an ascending auction for sale of one or more items. Equivalently, the description would apply with very minor and obvious modifications to descending auctions for purchase of items as well. It may also be noted that the same description can be easily extended to sealed bid auctions with the modification that each bidder submits its bid only once and the information on the current status of the auction is not revealed to the participants at any time before the close of the auction. Thus, the representative embodiment described above applies to a number of popular auction types with minor changes.

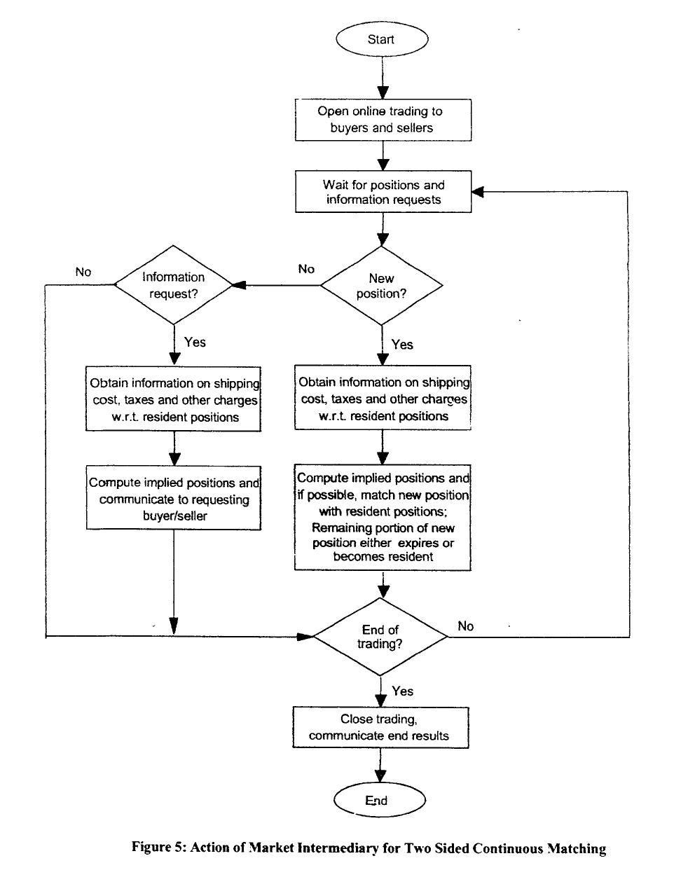

Yet another embodiment of the present invention described below with the help of the flow chart in FIG. 5 involves the use of two sided continuous matching as the market mechanism.

Two sided continuous matching is a very popular market mechanism, which is used all over the world in exchanges for trading financial instruments, commodities, and other items. Online trading, using two sided continuous matching is also made available by various stock and commodity exchanges. The embodiment explained below describes how such markets can be organized when shipping costs, taxes and other such end-to-end costs are significant and need to be taken into account.

Consider a two sided continuous matching market which may be enabling trading in a large number of items between multiple buyers and sellers. Consider the trading process for any one such item (for example, color monitors of a given specification; steel rolls of a given specification etc.). Any participant (a buyer or a seller) can submit a position (as defined in the general embodiment) to buy or to sell upto a specified number of units of the item. A position to buy is typically referred to as a bid and a position to sell is typically referred to as an offer. A buyer may indicate the per unit price by specifying an exact price, or an upper limit, or simply ask for the best available price in the market. Similarly, a seller can specify an exact price, a lower limit or ask for the best available price. Additionally, a participant may specify that its position is to remain valid for a specified time interval or that it may expire if it is not matched immediately. Buyers and sellers are indifferent as to who their trading counterparty may be and care only for the prices that they need to pay or receive.

The flow chart in FIG. 5 shows the important actions taken by the online market intermediary in an online trading scenario comprising two sided continuous matching in accordance with the embodiments of the present invention

The online market intermediary initiates the online trading by announcing the trading details on the Web site and/or sending messages to potential participants. Initially there are no resident (unmatched) bids and offers and the book of positions for the item (which can be defined as the list of all unmatched buy and sell positions for a given item at any time) is empty. In general, at any given time, the book of positions would contain unmatched bids and offers. For every unmatched offer (position to sell), the market intermediary stores the value of the required payout to seller (PS) which typically denotes the minimum per unit amount that the seller owning the given sell position desires. Similarly, for each unmatched bid (position to buy), the market intermediary stores the value of the required payment from buyer (PB) which typically denotes the maximum per unit amount that the buyer owning the given buy position may be willing to pay.

The market intermediary waits for any messages from the potential participants. The messages may comprise new bids and offers and information requests, besides other routine messages. Any participant can request for information on the current status of the trading or place a position in the online trading at any time before the trading is declared closed by the market intermediary.

When the market intermediary receives a message, which is not a new position, but is an information request from a potential participant, it typically handles the request as follows:

For a potential buyer seeking the information, the market intermediary obtains relevant information on the various components of the end-to-end costs that would apply if the given buyer were to buy by trading with the existing sell offers resident in the book of positions. This may include, for example, determining the shipping cost, determining the commissions and fees for various financial services to be availed and determining of the relevant taxes to be paid. The market intermediary then determines the implied minimum payment from buyer (minimum PB) for each of the resident sell position by computing a monetary value such that if the buyer were to buy by trading with the given sell position, then the net payout to the seller who owns the given sell position, after accounting for all the other costs (like shipping costs, taxes etc.) would be at least equal to the value of PS of the given sell position. The market intermediary thus creates a customized view of the sell positions resident in the book of positions for the requesting participant and communicates it to the participant.

Similarly, if the requesting participant is a potential seller, then the market intermediary creates a customized view of the buy positions resident in the book of positions for the requesting participant and communicates it to the participant.

When the market intermediary receives a message, which is indeed a new position, it first creates the customized view (as described above) of the bids or offers (depending on whether the new position is an offer or a bid respectively) resident in the book of positions from the point of view of the participant submitting the new position. It then attempts to match the new position with the existing counter-positions in accordance with the rules of the specific online marketplace. If there is a successful match (trade), the participants involved in the trade are notified. A position may be matched only partially (or not matched at all) with a counter-position. In such a case, and if the expiry-related specifications in the partially matched (or unmatched) positions so require, then the partially matched (or unmatched) positions may become resident in the book of positions.

After serving an information request or after processing a new position, the market intermediary checks if the trading should now be closed in accordance with the rules of the marketplace. If not, it goes back into the waiting mode to receive more positions and/or information requests. If yes, it closes the trading and the participants whose positions remain unmatched may be notified of the conclusion of the trading.

The embodiment described above with the help of FIG. 5 implements the present invention in the context of a two way continuous matching market. The embodiment may be practiced with minor modifications to fit the exact requirements of a given trading market.

It would be clear to a person skilled in the art that the embodiments in the present invention can be further applied to a number of other market mechanisms for online negotiations in a manner similar to that described in this document.

1. A method for enabling the online determination of end-to-end costs while negotiating e-commerce transactions comprising:
maintaining an updated online database of prices associated with each significant cost element relevant to goods or services involved in completing said transaction,
maintaining an updated online database of procedures and rules associated with each activity involved in completing said transaction,
determining the costs associated with each significant cost element by accessing the price data corresponding to the parameters of said transaction,
aggregating all said costs to arrive at a total end-to-end cost for said transaction.

2. The method as claimed in claim 1, further utilized for determining:
the set of e-commerce transactions that should take place and the set of e-commerce transactions that should not take place from amongst the various possibilities,
the prices to be paid by buyers, the amounts to be received by the sellers and the payments to be made to other service providers for the transactions that should take place.

3. The method as claimed in claim 1, wherein said cost elements include shipping and handling costs, other logistics management costs, taxes as well as finance costs.

4. The method as claimed in claim 1, wherein said databases are located either at the supplier end or at the buyer end or may be hosted by a third party.

5. The method as claimed in claim 1, wherein said procedures and rules include formalities to be completed and payments to be made for complying with statutory requirements at each end and intermediate step of said transaction.

6. The method as claimed in claim 1, wherein said method is implemented by an online intermediary providing said facilities as a service either against a fee of commission or free of charge.

7. The method as claimed in claim 1, applied to transactions between a single buyer and a single seller negotiating online.

8. The method as claimed in claim 1, applied to online auctions between a seller and multiple buyers.

9. The method as claimed in claim 1, applied to online reverse auctions between a buyer and multiple sellers.

10. The method as claimed in claim 6, applied to two-sided matching markets involving multiple buyers and sellers.

11. The method as claimed in claim 8 wherein the winning bid for the desired goods or services in an online auction is selected on the basis of highest net payout to the seller after deduction of said computed cost elements (shipping, logistics, fees, commissions).

12. The method as claimed in claim 9 wherein the winning offer for the desired goods or services in an online reverse auction is selected on the basis of lowest net cost to the buyer after addition of said computed cost elements (shipping, logistics, fees, commissions).

13. The method as claimed in claim 8 wherein a minimum required qualifying bid amount is communicated to a potential bidder in response to request for the information about the current status of the auctions.

14. The method as claimed in claim 9 wherein a maximum allowable offer amount is communicated to a potential seller in response to request for the information about the current status of the reverse auctions.

15. The method as claimed in claim 10 wherein the sell orders resident in the database are shown to a potential buyer after online addition of said computed cost elements (shipping, logistics, fees, commissions) to the price quoted by seller for each of the sell orders in response to request for such information in a two-sided matching market.

16. The method as claimed in claim 10 wherein the buy orders resident in the database are shown to a potential seller after online deduction of said computed cost elements (shipping, logistics, fees, commissions) from the price quoted by buyer for each of the sell orders in response to request for such information in a two-sided matching market.

17. The method as claimed in claim 10 wherein the resident sell orders are prioritized for matching an incoming buy order in the increasing order of the total cost computed by addition of said computed cost elements (shipping, logistics, fees, commissions) to the price quoted by seller for each of the sell orders in a two-sided matching market.

18. The method as claimed in claim 10 wherein the resident buy orders are prioritized for matching an incoming sell order in the decreasing order of the net price computed by deduction of said computed cost elements (shipping, logistics, fees, commissions) to the price quoted by buyer for each of the buy orders in a two-sided matching market.

19. A system for enabling the online determination of end-to-end costs while negotiating e-commerce transactions comprising:
means for maintaining an updated online database of prices associated with each significant cost element relevant to goods or services involved in completing said transaction,
means for maintaining an updated online database of procedures and rules associated with each activity involved in completing said transaction,
means for determining the costs associated with each significant cost element by accessing the price data corresponding to the parameters of said transaction,
means for aggregating all said costs to arrive at a total end-to-end cost for said transaction.

20. The system as claimed in claim 19, further utilized for determining:
the set of e-commerce transactions that should take place and the set of e-commerce transactions that should not take place from amongst the various possibilities,
the prices to be paid by buyers, the amounts to be received by the sellers and the payments to be made to other service providers for the transactions that should take place.

21. The system as claimed in claim 19, wherein said cost elements include shipping and handling costs, other logistics management costs, taxes as well as finance costs.

22. The system as claimed in claim 19, wherein said databases are located either at the supplier end or at the buyer end or may be hosted by a third party.

23. The system as claimed in claim 19, wherein said procedures and rules include formalities to be completed and payments to be made for complying with statutory requirements at each end and intermediate step of said transaction.

24. The system as claimed in claim 19, wherein said system is used by an online intermediary providing said facilities as a service either against a fee of commission or free of charge.

25. The system as claimed in claim 19, used for transactions between a single buyer and a single seller negotiating online.

26. The system as claimed in claim 19, used for online auctions between a seller and multiple buyers.

27. The system as claimed in claim 19, used for online reverse auctions between a buyer and multiple sellers.

28. The system as claimed in claim 24 used for two-sided matching markets involving multiple buyers and sellers.

29. The system as claimed in claim 26, including means for selecting the winning bid for the desired goods or services in an online auction on the basis of highest net payout to the seller after deduction of said computed cost elements (shipping, logistics, fees, commissions).

30. The system as claimed in claim 27, including means for selecting the winning offer for the desired goods or services in an online reverse auction on the basis of lowest net cost to the buyer after addition of said computed cost elements (shipping, logistics, fees, commissions).

31. The system as claimed in claim 26, including means for communicating minimum required qualifying bid amount to a potential bidder in response to request for the information about the current status of the auctions.

32. The system as claimed in claim 27, including means for communicating maximum allowable offer amount to a potential seller in response to request for the information about the current status of the reverse auctions.

33. The system as claimed in claim 28, including means for showing the sell orders resident in the database to a potential buyer after online addition of said computed cost elements (shipping, logistics, fees, commissions) to the price quoted by seller for each of the sell orders in response to request for such information in a two-sided matching market.

34. The system as claimed in claim 28, including means for showing the buy orders resident in the database to a potential seller after online deduction of said computed cost elements (shipping, logistics, fees, commissions) from the price quoted by buyer for each of the sell orders in response to request for such information in a two-sided matching market.

35. The system as claimed in claim 28, including means for prioritizing the resident sell orders for matching an incoming buy order in the increasing order of the total cost computed by addition of said computed cost elements (shipping, logistics, fees, commissions) to the price quoted by seller for each of the sell orders in a two-sided matching market.

36. The system as claimed in claim 28, including means for prioritizing the resident buy orders for matching an incoming sell order in the decreasing order of the net price computed by deduction of said computed cost elements (shipping, logistics, fees, commissions) to the price quoted by buyer for each of the buy orders in a two-sided matching market.

37. A computer program product comprising computer readable program code stored on computer readable storage medium embodied therein for enabling the online determination of end-to-end costs while negotiating e-commerce transactions comprising:
computer readable program code means configured for maintaining an updated online database of prices associated with each significant cost element relevant to goods or services involved in completing said transaction,
computer readable program code means configured for maintaining an updated online database of procedures and rules associated with each activity involved in completing said transaction,
computer readable program code means configured for determining the costs associated with each significant cost element by accessing the price data corresponding to the parameters of said transaction,
computer readable program code means configured for aggregating all said costs to arrive at a total end-to-end cost for said transaction.

38. The computer program product as claimed in claim 37, further configured for determining:
the set of e-commerce transactions that should take place and the set of e-commerce transactions that should not take place from amongst the various possibilities,
the prices to be paid by buyers, the amounts to be received by the sellers and the payments to be made to other service providers for the transactions that should take place.

39. The computer program product as claimed in claim 37, wherein said cost elements include shipping and handling costs, other logistics management costs, taxes as well as finance costs.

40. The computer program product as claimed in claim 37, wherein said databases are located either at the supplier end or at the buyer end or may be hosted by a third party.

41. The computer program product as claimed in claim 37, wherein said procedures and rules include formalities to be completed and payments to be made for complying with statutory requirements at each end and intermediate step of said transaction.

42. The computer program product as claimed in claim 37, wherein said computer program product is implemented by an online intermediary providing said facilities as a service either against a fee of commission or free of charge.

43. The computer program product as claimed in claim 37, configured for transactions between a single buyer and a single seller negotiating online.

44. The computer program product as claimed in claim 37, configured for online auctions between a seller and multiple buyers.

45. The computer program product as claimed in claim 37, configured for online reverse auctions between a buyer and multiple sellers.

46. The computer program product as claimed in claim 42, configured for two-sided matching markets involving multiple buyers and sellers.

47. The computer program product as claimed in claim 44, including computer readable program code means configured for selecting the winning bid for the desired goods or services in an online auction on the basis of highest net payout to the seller after deduction of said computed cost elements (shipping, logistics, fees, commissions).

48. The computer program product as claimed in claim 45, including computer readable program code means configured for selecting the winning offer for the desired goods or services in an online reverse auction on the basis of lowest net cost to the buyer after addition of said computed cost elements (shipping, logistics, fees, commissions).

49. The computer program product as claimed in claim 44, including computer readable program code means configured for communicating minimum required qualifying bid amount to a potential bidder in response to request for the information about the current status of the auctions.

50. The computer program product as claimed in claim 45, including computer readable program code means configured for communicating maximum allowable offer amount to a potential seller in response to request for the information about the current status of the reverse auctions.

51. The computer program product as claimed in claim 46, including computer readable program code means configured for showing the sell orders resident in the database to a potential buyer after online addition of said computed cost elements (shipping, logistics, fees, commissions) to the price quoted by seller for each of the sell orders in response to request for such information in a two-sided matching market.

52. The computer program product as claimed in claim 46, including computer readable program code means configured for showing the buy orders resident in the database to a potential seller after online deduction of said computed cost elements (shipping, logistics, fees, commissions) from the price quoted by buyer for each of the sell orders in response to request for such information in a two-sided matching market.

53. The computer program product as claimed in claim 46, including computer readable program code means configured for prioritizing the resident sell orders for matching an incoming buy order in the increasing order of the total cost computed by addition of said computed cost elements (shipping, logistics, fees, commissions) to the price quoted by seller for each of the sell orders in a two-sided matching market

54. The computer program product as claimed in claim 46, including computer readable program code means configured for prioritizing the resident buy orders for matching an incoming sell order in the decreasing order of the net price computed by deduction of said computed cost elements (shipping, logistics, fees, commissions) to the price quoted by buyer for each of the buy orders in a two-sided matching market.
